(19) United States
(12) Patent Application Publication
(10) Pub. No.: US 2004/0072645 A1
(43) Pub. Date: Apr. 15, 2004

(54) Power transmission apparatus

(76) Inventor: Peter Bortolin, Stanmore NSW (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/398,945

(22) PCT Filed: Oct. 4, 2001
(86) PCT No.: PCT/AU01/01245

(30) Foreign Application Priority Data
Oct. 6, 2000 (AU) PR 0582

(51) Int. Cl. F16H 35/02; F16H 37/12

(52) U.S. Cl. 475/17; 475/331

(57) ABSTRACT

A power transmission apparatus (10) including a base (13) with a driven shaft (11) rotably supported by the base (11) is disclosed. The apparatus (10) further includes an internal gear (17) surrounding the shaft (11) and fixed to the base (13), an arm (14) fixed to the shaft (11) and extending generally radially therefrom, a planetary gear (16) rotably attached to the arm (14) and meshingly engaged with the internal gear (17) so that rotation of said planetary gear (16) causes rotation of the shaft (11), and a connecting rod (19) rotably attached to an extension (20) fixed to the planetary gear (16) so that a means driving the connecting rod (19) causes rotation of the planetary gear (16), the connecting rod (19) being attached to the planetary gear (19) at a predetermined location from the planetary gear (16) by the length of the extension (20) and the connecting rod (19) angularly oscillating across a transverse axis of the shaft (11).

The present invention relates to power transmission apparatus and more particularly but not exclusively to crank mechanisms employed in internal combustion engines, both two stroke and four stroke engines and to bicycle chain mechanisms.

### BACKGROUND TO THE INVENTION

Internal combustion engines are limited as best advantage is not taken of the forces applied to the piston in generating torque. A further disadvantage of known internal combustion engines is that the combustion process is often not efficiently executed.

Similarly, bicycle chain transmission mechanisms are relatively efficient, however there is possibility of greater torque being able to be obtained.

### OBJECT OF THE INVENTION

It is the object of the present invention to overcome or substantially ameliorate the above disadvantages.

### SUMMARY OF THE INVENTION

According to one aspect of the present invention there is disclosed herein a power transmission apparatus including a base: a driven shaft rotatably supported by the base,

an internal gear surrounding the shaft and fixed to the base, an arm fixed to the shaft and extending generally radially therefrom, a planetary gear rotably attached to the arm and meshingly engaged with the internal gear so that rotation of said planetary gear causes rotation of said shaft, and

a connecting rod rotably attached to an extension fixed to the planetary gear so that a piston driving said connecting rod causes rotation of said planetary gear, said connecting rod being attached to said planetary gear at a predetermined location from said planetary gear by the length of the extension and wherein said connecting rod angularly oscillates across a transverse axis of said shaft.

According to another aspect, there is disclosed a power transmission apparatus including a base: a driven shaft rotably supported by the base.

an internal gear surrounding the shaft and fixed to the base, an arm rotably attached to the shaft and extending generally radially therefrom, a planetary gear fixed to the arm and meshingly engaged with the internal gear so that rotation of said planetary gear causes rotation of said shaft, and

a connecting rod rotably attached to the planetary gear so that a pedal rotating said connecting rod causes rotation of said planetary gear, and wherein said connecting rod angularly oscillates across a transverse axis of said shaft.

According to another aspect, there is disclosed a power transmission apparatus including a base: a driven shaft rotably supported by the base; an arm rotably attached to the shaft and extending generally radially therefrom; a secondary arm pivotally attached to the outer end of the radial crank arm, and at the opposite end of the said secondary arm, rotably attached thereto, a piston-driven connecting rod causes rotation of the radial crank arm, wherein said connecting rod angularly oscillates across a transverse axis of said shaft.

Preferably a guide means is used to guide the movement of the connecting rod.

According to another aspect, there is disclosed a power transmission apparatus including a base: a driven shaft rotably supported by the base; an arm rotably attached to the shaft and extending generally radially therefrom; a secondary arm pivotally attached to the outer end of the radial crank arm; and at the opposite end of the said secondary arm, rotably attached, is a further arm which has a pedal attached at the outer end wherein guides restrict the pedals to a chosen path and when force is applied to the pedals, it causes rotation of the radial crank arm.

### BRIEF DESCRIPTION OF THE DRAWINGS

Preferred forms of the present invention will now be described by way of example with reference to the accompanying drawings wherein:

FIG. 1 is a schematic end elevation of a power transmission apparatus of an internal combustion engine of a first embodiment;

FIG. 2 is a schematic side view of a bicycle having a transmission of a preferred embodiment.

FIG. 3 is a schematic end elevation of a power transmission apparatus of an internal combustion engine of a further embodiment;

FIG. 4 is a schematic end elevation of a power transmission apparatus of a bicycle of a still further embodiment;

FIG. 5 is a schematic end elevation of a power transmission apparatus of a bicycle (showing one pedal) of a still further embodiment;

FIG. 6 is a schematic end elevation of a power transmission apparatus of a bicycle of FIG. 6 (showing the other pedal);

FIG. 7 is a schematic side view elevation of a power transmission apparatus of a bicycle of another embodiment; and

FIG. 8 is a schematic plan view elevation of the power transmission apparatus of a bicycle of FIG. 7.

### BEST MODE OF CARRYING OUT THE INVENTION

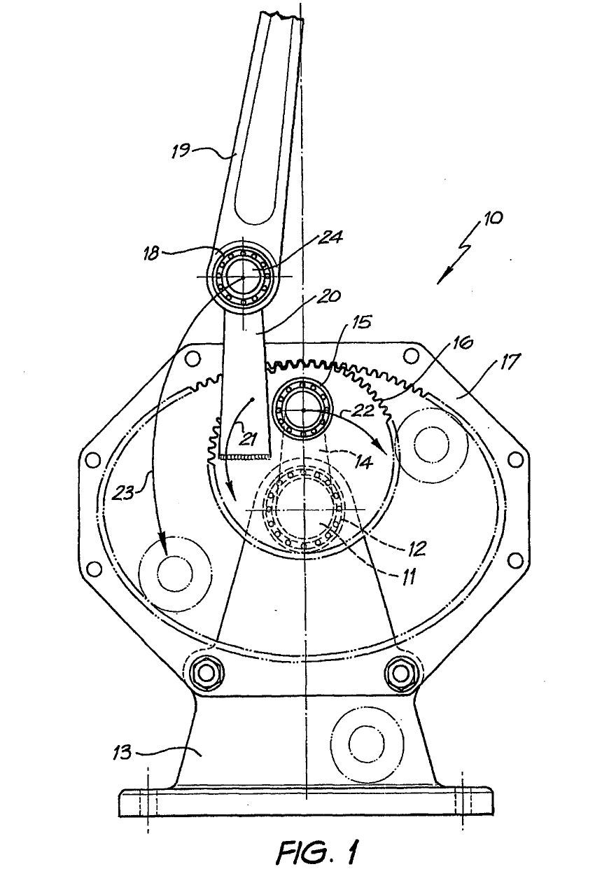

In FIG. 1 of the accompanying drawings there is schematically depicted a crank assembly 10 for an internal combustion engine. The crank assembly 10 includes a main driven shaft 11 supported for rotation by means of bearings 12 on a base 13. Extending from the shaft 11 is a radial crank arm 14 terminating at its radial extremity with a bearing 15. The bearing 15 supports a planetary gear 16 (that can be of different shape), meshingly engaged with an elliptical ring gear 17 attached to the base 13. Rotably attached to the planetary gear 16 by bearing 18 is a connecting rod 19 of an internal combustion engine by means of an extension 20 in an offset manner.

A driving force connected to the connecting rod 19 causes rotation of the planetary gear 16 in the direction of the arrow 21 due to meshing engagement with the internal ring gear 17. The radial crank arm 14 will rotate in the direction of the arrow 22.

A connecting pin 24 supporting the bearing 18 moves along a general path arrows 23. In this configuration with its proportional dimensions the connecting pin 24 is at some convenient distance past the perimeter of the planetary gear by the extension 20. Also, the pivoting-point of the planetary gear 16 is away from its centre due to the position of the fixing of the extension 20.

The above mechanism, with its configuration, has the potential right from the top dead centre down to some 135-140 degrees of the downstroke to maximise the piston's displacement, resulting in greater torque output.

Although the elliptical ring gear 17 can be positioned at any angle, the horizontal position as seen in the drawings appears to be the most efficient.

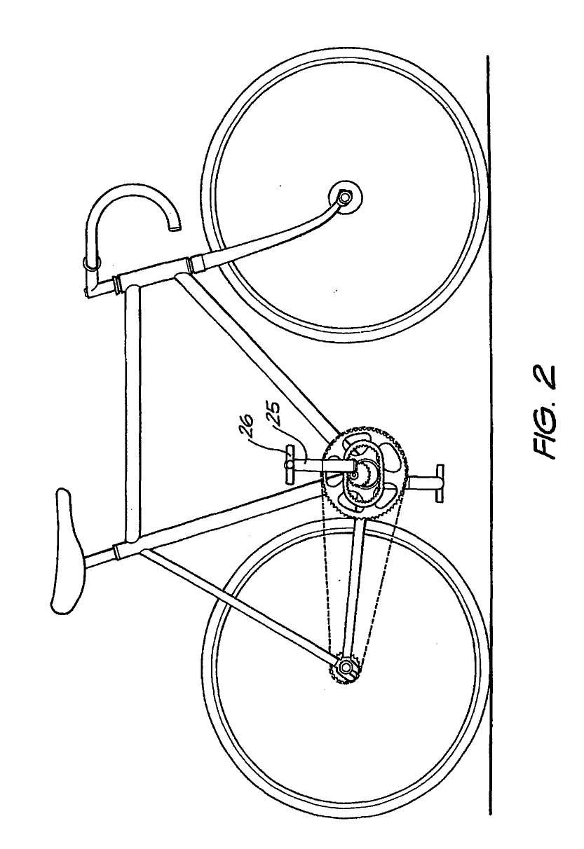

In the embodiment of the invention when it is used for the transmission gears of a bicycle as seen in FIG. 2, the connecting rod 19 is replaced by a pedal rod 25 which is rotated by force on the pedal 26. The pedal rod 25 is fixed to the planetary gear 16 in an offset manner similar to the connecting rod 20 in FIG. 1 and as it is rotated, it forces the planetary gear 16 to rotate in an identical manner to that of the embodiment of FIG. 1. The rotation of the main drive shaft which is supported by a base of the bicycle chassis is used to rotate the rear wheel of the bicycle in the usual manners. The pedal rod 25 can also be fixes at any other offset angle for convenience.

The pedals' crank arms can be positioned at any of 360 degree angles in relation to the driven crank shaft for the rider's convenience.

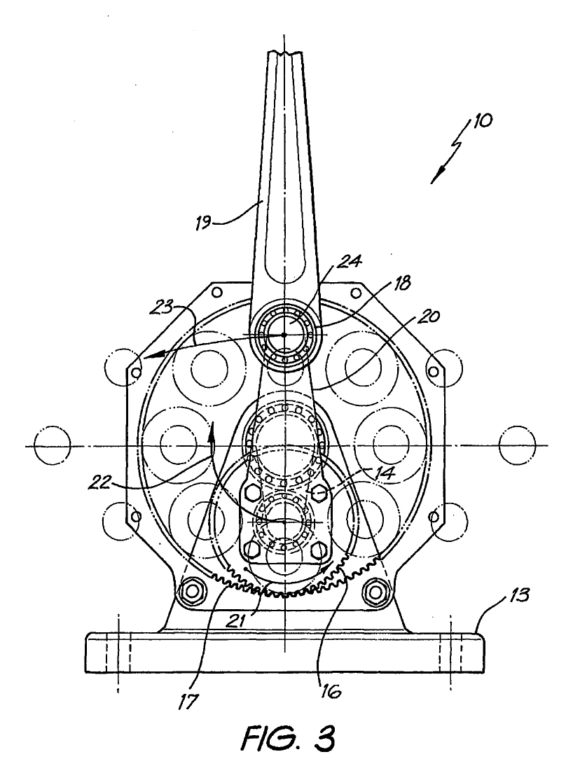

In the embodiment as seen in FIG. 3 of the accompanying drawings there is schematically depicted a crank assembly 10 for an internal combustion engine. The crank assembly 10 is basically the same as the embodiment of FIG. 2 with the difference being that the ring gear 17 is circular and the bearing is located at the centre of the planetary gear 16 with the extension 20 also being located adjacent the centre of the planetary gear 16. In this configuration, with its proportional dimensions the connecting pin is at some convenient distance past the perimeter of the planetary gear. Furthermore, it is noted that the horizontal and vertical movements are exploited. Also, by implementing proportional dimensions of the various parts of the mechanism, the downstroke is completed when the crank 14 has reached the 135 degree angle. Consequently, much greater torque output is achieved, when compared to a conventional combustion engine of similar stroke. In a variation where the ring gear 17 is elliptical, there is a greater piton displacement which results in greater torque with the stroke being completed at 90 degrees.

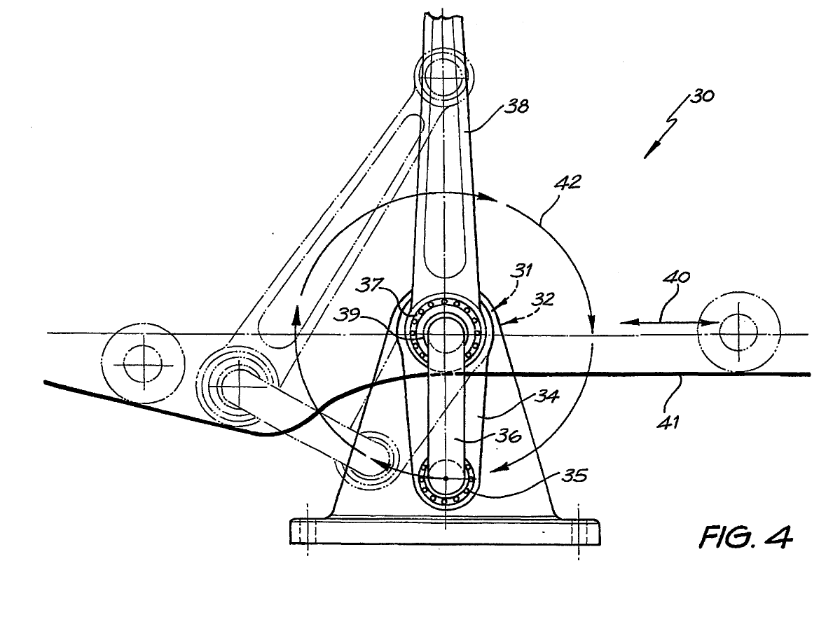

In the embodiment as illustrated in FIG. 4. There is schematically depicted a crank assembly 30 for an internal combustion engine. The crank assembly 30 includes a main driven shaft 31 supported for rotation by means of bearing 32. Extending from the shaft 31 is a radial crank arm 34 terminating at its radial extremity with a bearing 35. The bearing 35 supports an arm 36 rotably engaged with the arm 34. Rotably engaged with the arm 34 by a bearing 37 is a connecting rod 38 of the internal combustion engine.

A driving force applied and connected to the connecting rod 18 causes a connecting pin 39 which supports the bearing 32 to slide along a horizontal path shown by arrows 40 controlled by a guide 41. The radial crank arm 34 will then rotate in the direction of arrow 42.

In this embodiment, horizontal and vertical movements are exploited. Futhermore, by implementing the proportional dimensions of the various parts of the mechanism, the downstroke is completed when the crank 34 has reached the 90 degree angle. This can also be completed at other angles, if required, by inclining downward a section of the guide 42.

Consequently, much greater torque output is achieved, when compared to a conventional internal combustion engine of similar stroke, and it also makes it possible to achieve four-stroke compression with a two-stroke operation; ie combustion at every 360 degrees crankshaft rotation. It is then seen that the work is done faster thereby minimising heat losses. The length of the connection rod is crucial to obtain all the above mentioned advantages. Further, positive torque output is achieved for the duration of the stroke.

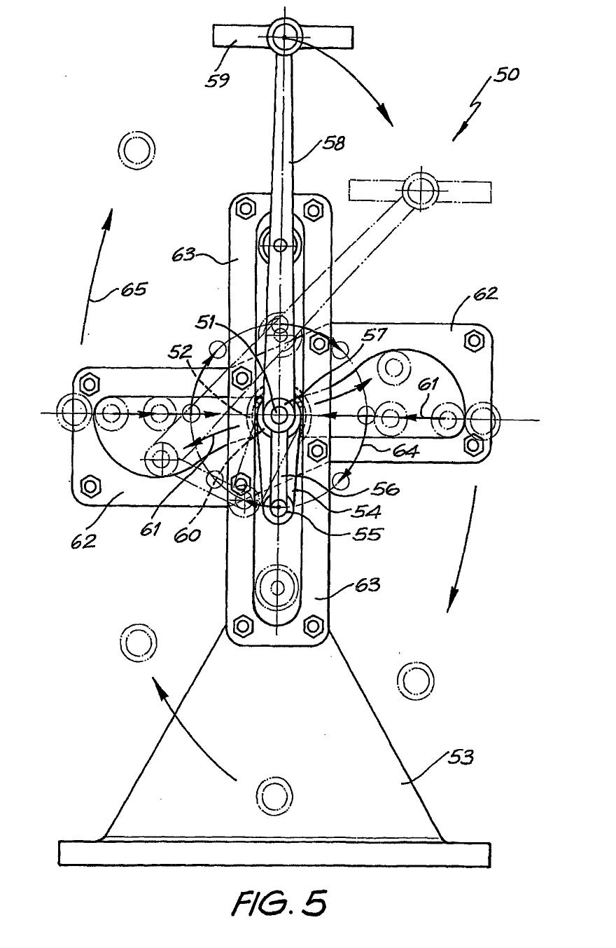

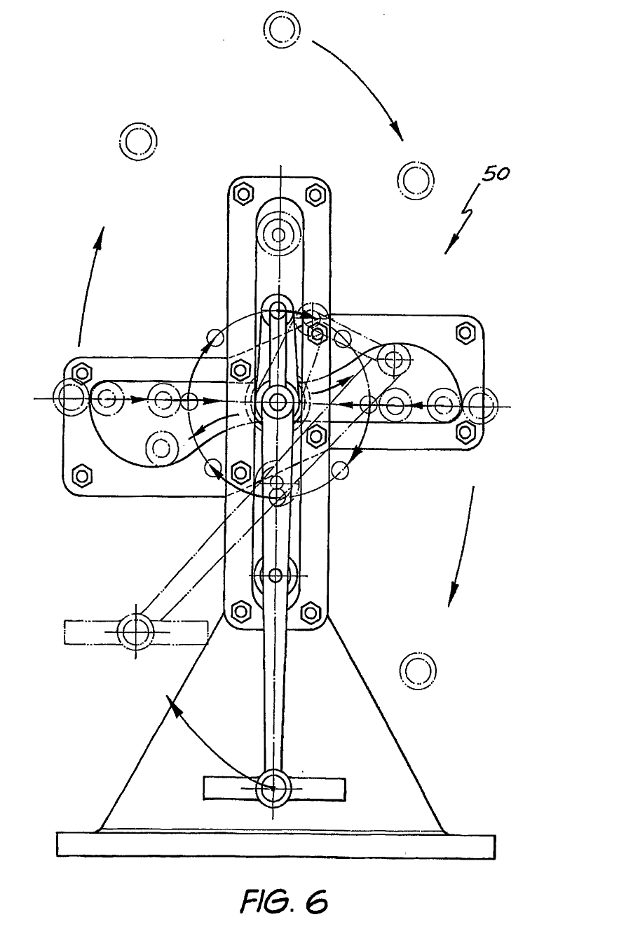

A crank assembly 50 for a bicycle of another embodiment is schematically illustrated in FIGS. 5 and 6. The crank assembly 50 includes a main driven shaft 51 supported for rotation by means of bearings 52 on a base 53. Extending from the shaft 51 is a radial crank arm 54 terminating at its radial extremity with a bearing 55. The bearing 55 supports a secondary arm 56, rotably engaged with the arm 54. Rotably attached at the other extremity of the arm 56 by bearing 57 is a pedal arm 58 of a bicycle to which a pedal 59 is attached. This arrangement is also applicable to other vehicles, such as an internal combustion engine etc.

A driving force applied to the pedal 59 causes a connecting pin 60 supporting the bearing 57 to slide along a path arrows 61 controlled by guides 62 and 63. The radial crank arm 54 will rotate in the direction of arrows 64. The pedal arm 58 will rotate in the direction of arrows 65.

It is noted that in this arrangement, the pedal path is elliptical, thus reducing the time for completion of the stroke, or alternatively, proportionately increase the stroke in order to obtain similar pedal path length to that of the conventional mechanism.

The pedals' crank arms can be positioned at any of 360 degree angles in relation to the driven crank shaft for the rider's convenience.

Guides 62 and 63 can be of other shapes, although, as in FIGS. 5 and 6, a particularly fast pedal displacement is achieved in the first 40 degrees of the pedal path.

These mechanisms, as outlined above, produce constant, positive and greater torque output.

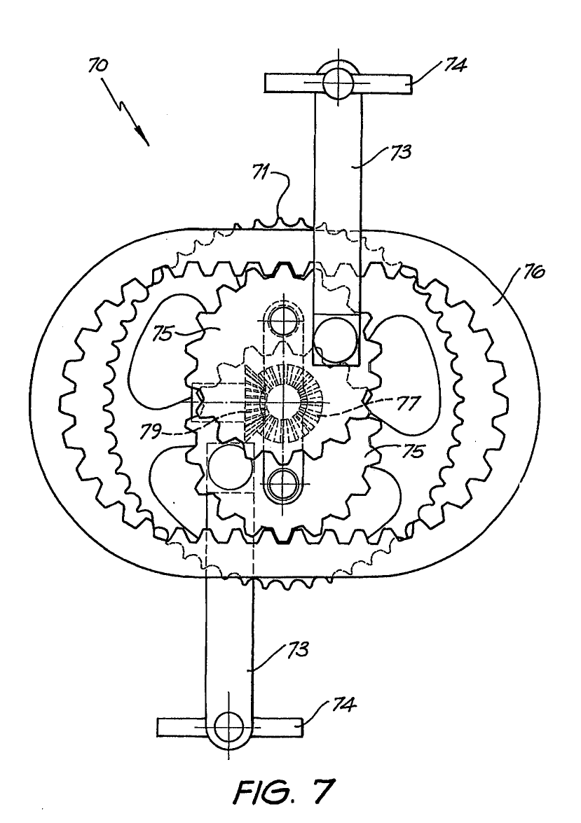

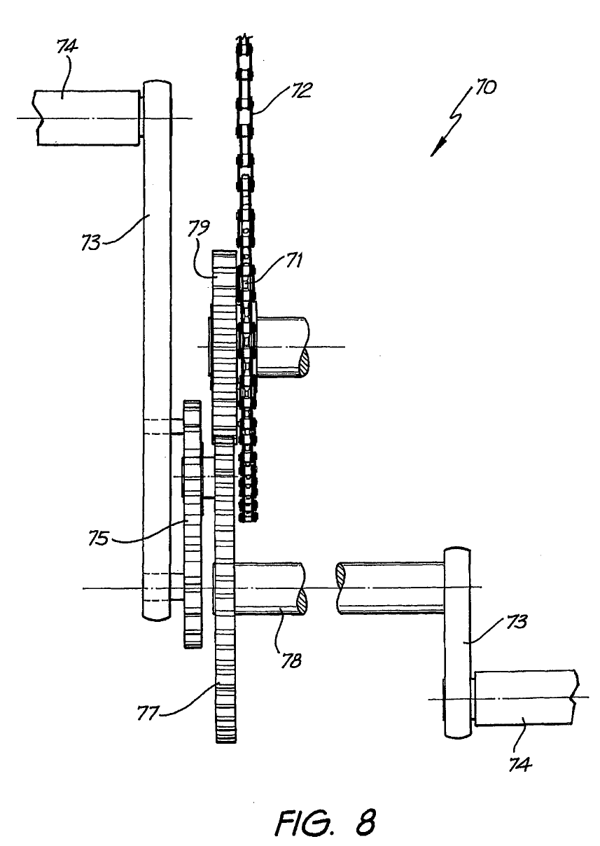

The bicycle arrangement as illustrated in FIGS. 7 and 8 is used to provide a drive arrangement in both directions for a bicycle. The mechanism 70 includes a geared sprocket 71 on which a chain 72 (not illustrated in FIG. 7 for clarity) is attached which in turn is used to drive the rear wheel of a bicycle. The mechanism 70 also includes two pedal rods 73 to which pedals 74 are attached. Each of the pedal rods 74 has a planetary sprocket 75 rotably attached thereto, the planetary sprocket 75 being adapted to operate with an elliptical gear 76 (not illustrated in FIG. 8 for clarity) as described in the previous embodiments which to provide greater torque during its travel in the elliptical gear 76. The sprocket 75 is fixed to a gear 77 which rotates about a pedal axis 78, the gear 77 interacting with a reversible gear 79 to drive the sprocket 71 on which the chain 72 is attached. The reversible gear 79 operates such that when the pedals are reversed the chain 72 is driven in both directions following the direction of pedaling.

The foregoing describes only some embodiments of the present invention, and modifications obvious to those skilled in the art can be made thereto without departing from the scope of the present invention.

1. A power transmission apparatus including a base: a driven shaft rotably supported by the base,
an internal gear surrounding the shaft and fixed to the base, an arm fixed to the shaft and extending generally radially therefrom, a planetary gear rotably attached to the arm and meshingly engaged with the internal gear so that rotation of said planetary gear causes rotation of said shaft, and
a connecting rod rotably attached to an extension fixed to the planetary gear so that a means driving said connecting rod causes rotation of said planetary gear, said connecting rod being attached to said planetary gear at a predetermined location from said planetary gear by the length of the extension and wherein said connecting rod angularly oscillates across a transverse axis of said shaft.

2. A power transmission apparatus including a base: a driven shaft rotably supported by the base,
an internal gear surrounding the shaft and fixed to the base, an arm fixed to the shaft and extending generally radially therefrom, a planetary gear rotably attached to the arm and meshingly engaged with the internal gear so that rotation of said planetary gear causes rotation of said shaft, and
a connecting rod rotably attached to an extension fixed to the planetary gear so that a piston driving said connecting rod causes rotation of said planetary gear, said connecting rod being attached to said planetary gear at a predetermined location from said planetary gear by the length of the extension and wherein said connecting rod angularly oscillates across a transverse axis of said shaft.

3. The power transmission apparatus according to claims 1 or 2, wherein the internal gear is formed with an elliptical ring gear shape.

4. The power transmission apparatus according to claim 3, wherein the internal gear which is formed with an elliptical ring gear shape is positioned horizontally.

5. The power transmission apparatus according to claim 3, wherein the extension is fixed offset from the centre of the planetary gear such that the pivoting-point of the planetary gear is also offset.

6. The power transmission apparatus according to any one of claims 1-5, wherein the apparatus is used in an internal combustion engine.

7. A power transmission apparatus including a base: a driven shaft rotably supported by the base.
an internal gear surrounding the shaft and fixed to the base, an arm fixed to the shaft and extending generally radially therefrom, a planetary gear rotably attached to the arm and meshingly engaged with the internal gear so that rotation of said planetary gear causes rotation of said shaft, and
a connecting rod rotably attached to the planetary gear so that a pedal rotating said connecting rod causes rotation of said planetary gear, and wherein said connecting rod angularly oscillates across a transverse axis of said shaft.

8. A power transmission apparatus including a base: a driven shaft rotably supported by the base; an arm rotably attached to the shaft and extending generally radially therefrom; a secondary arm pivotally attached to the outer end of the radial crank arm, and at the opposite end of the said secondary arm, rotably attached thereto, a connecting rod causes rotation of the radial crank arm, wherein said connecting rod angularly oscillates across a transverse axis of said shaft.

9. The power transmission apparatus according to claim 8, wherein the connecting-rod is piston driven.

10. The power transmission apparatus according to claims 8 and 9, wherein guide means is used to guide the movement of the connecting rod.

11. A power transmission apparatus including a base: a driven shaft rotably supported by the base; an arm rotably attached to the shaft and extending generally radially therefrom; a secondary arm pivotally attached to the outer end of the radial crank arm; and at the opposite end of the said secondary arm, rotably attached, is a further arm which has a drive means attached at the outer end wherein guides restrict the pedals to a chosen path and when force is applied to the pedals, it causes rotation of the radial crank arm.

12. The power transmission apparatus according to claim 11, wherein drive means is a pedal.
